(19) United States
(12) Patent Application Publication
(10) Pub. No.: US 2018/0270049 A1
(43) Pub. Date: Sep. 20, 2018

(54) TECHNIQUES FOR PREVENTING ABUSE OF BOOTSTRAPPING INFORMATION IN AN AUTHENTICATION PROTOCOL

(71) Applicant: QUALCOMM Incorporated, San Diego, CA (US)

(72) Inventors: Rosario CAMMAROTA, San Diego, CA (US); Jouni MALINEN, Tuusula (FI); Shivraj Singh SANDHU, Milpitas, CA (US)

(21) Appl. No.: 15/921,463

(22) Filed: Mar. 14, 2018

Related U.S. Application Data
(60) Provisional application No. 62/473,064, filed on Mar. 17, 2017.

(51) Int. Cl. H04L 9/08; H04L 9/32; G06F 9/4401

(52) U.S. Cl. CPC H04L 9/088; G06F 9/4401; H04L 9/32

(57) ABSTRACT

Aspects of the present disclosure implement techniques that allow an enrollee (e.g., DPP-AP or other DPP devices) to be informed of the bootstrapping method selected by a device (e.g., STA) when initiating onboarding. As such, in one example, authentication requests from the device may additionally carry information that inform the network of the bootstrapping method (e.g., QR-code, NFC, Wi-Fi Aware, Wi-Fi Direct) selected by the device. Each bootstrapping method may correspond to an authentication key. Accordingly, based on the exchange of bootstrapping information, the enrollee (e.g., network device) may verify the authenticity of the device by calculating an authentication key that unlocks additional sensitive information that may be included in the authentication request.

### CROSS-REFERENCE TO RELATED APPLICATION(S)

This application claims the benefit of U.S. Provisional Application Ser. No. 62/473,064, entitled “TECHNIQUES FOR PREVENTING ABUSE OF BOOTSTRAPPING INFORMATION IN AN AUTHENTICATION PROTOCOL” and filed Mar. 17, 2017, which is expressly incorporated by reference herein in its entirety.

### BACKGROUND

The present disclosure relates generally to telecommunications, and specifically to communications security management to prevent abuse of bootstrapping information in device provisioning protocol (DPP) during an authentication protocol.

The deployment of wireless local area networks (WLANs) in the home, the office, and various public facilities is commonplace today. Such networks typically employ a wireless access point (AP) that connects a number of wireless stations (STAs) in a specific locality (e.g., home, office, public facility, etc.) to another network, such as the Internet or the like. In a wireless communications system, an AP may provide a STA with access to the communication system or network. Communication on the wireless interface between the STA and the AP can be based on an appropriate communication protocol.

Prior to establishing communication with a wireless network, a device such as a STA may need to be authenticated by the network before the device is allowed to access or otherwise use various applications and services provided by the network. This may be required for security and privacy reasons, but, in some cases, also to enable correct billing of the service usage. The DPP allows initiating of device onboarding (e.g., enrolling or provisioning the device onto the wireless network) using different methods (e.g., quick response code (QR-code), near field communication (NFC), Wi-Fi Aware, Wi-Fi Direct, etc.). The terms “onboarding” and “enrolling” may be used interchangeably to describe the process where a device is provided with the appropriate configuration to access the network securely. Each of the different methods may be classified as either out-of-band techniques or in-band techniques. The term “out-of-band” may refer to techniques that establish a separate communication link that is removed from the general network, whereas the term “in-band” may refer to techniques that exchange communication over a shared network. Because in-band techniques (e.g., Wi-Fi Aware, Wi-Fi Direct) require exchange of information over a shared network, devices that use in-band techniques for onboarding in accordance with conventional DPP may be susceptible to a malicious attack by third-party devices that may intercept sensitive bootstrapping information (e.g., information to facilitate authentication) for non-legitimate purposes.

### SUMMARY

Aspects of the present disclosure solve the above-identified problem by implementing techniques that allow an enrollee (e.g., DPP-AP or other DPP devices) to be informed of the bootstrapping method selected by the device (e.g., STA) when initiating onboarding. As such, in one example, the authentication messages from the device may additionally carry information that inform the network of the bootstrapping method (e.g., QR-code, NFC, Wi-Fi Aware, Wi-Fi Direct) selected by the device. Each bootstrapping method may correspond to public credentials for bootstrapping. Accordingly, based on the exchange of bootstrapping information, the enrollee (e.g., network) may verify the authenticity of the device by calculating an authentication key that unlocks additional sensitive information that may be included in the authentication request. Absent the correct authentication key, the sensitive bootstrapping information may be prevented from being compromised to third-party attackers. Additionally or alternatively, if the bootstrapping method is a QR-code, the authentication request may include a random identification (ID) to the QR-code format such that its hash may be verified by the enrollee.

In one example of the present disclosure, a method for wireless communication implemented by a device provisioning protocol (DPP) enabled device is disclosed. In some examples, the method may include receiving, at a first DPP enabled device, an authentication request from a second DPP enabled device to initiate an authentication protocol. The authentication request may identify a bootstrapping method selected from a plurality of bootstrapping methods. The method may further include determining an authentication key in response to the identification of the bootstrapping method, and applying the authentication key to unlock protected bootstrapping information that is included in the authentication request.

In another example, a DPP enabled device for wireless communications is disclosed. The DPP enabled device may include a processor and a memory coupled to the processor. The memory may further include instructions executable by the processor to receive, at a first DPP enabled device, an authentication request to initiate an authentication protocol with a second DPP enabled device. The authentication request identifies a bootstrapping method selected from a plurality of bootstrapping methods. The DPP enabled device may further include determining an authentication key in response to the identification of the bootstrapping method. The DPP enabled device may further include applying the authentication key to unlock protected bootstrapping information that is included in the authentication request.

In another example, a computer-readable medium storing computer executable code for wireless communications is disclosed. The computer-readable medium may include code for receiving, at a first DPP enabled device, an authentication request from a second DPP enabled device to initiate an authentication protocol. The authentication request may identify a bootstrapping method selected from a plurality of bootstrapping. The computer-readable medium may further include code for determining an authentication key in response to the identification of the bootstrapping method, and applying the authentication key to unlock protected bootstrapping information that is included in the authentication request.

In another example, an apparatus for wireless communications is disclosed. The apparatus may include means for receiving, at a first DPP enabled device, an authentication request from a second DPP enabled device to initiate an authentication protocol. The authentication request may identify a bootstrapping method selected from a plurality of bootstrapping. The apparatus may further include means for determining an authentication key in response to the identification of the bootstrapping method, and means for applying the authentication key to unlock protected bootstrapping information that is included in the authentication request.

It is understood that other aspects of apparatuses and methods will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is a conceptual diagram illustrating an example of a wireless local area network (WLAN) deployment;

FIGS. 2A and 2B are call flow diagrams of example of techniques for provisioning a device with a DPP-device in accordance with aspects of the present disclosure;

FIG. 3 is a schematic diagram of a device including an aspect of an AP that may implement various aspects of the present disclosure;

FIG. 4 illustrates one example of a flowchart that shows aspects of the AP in accordance with the first technique of the present disclosure;

FIG. 5 illustrates another example of a flowchart that shows aspects of the AP in accordance with the second technique of the present disclosure;

FIG. 6 is a schematic diagram of a device including an aspect of an STA that may implement various aspects of the present disclosure;

FIG. 7 illustrates one example of a flowchart that shows aspects of the STA in accordance with the first technique of the present disclosure; and

FIG. 8 illustrates another example of a flowchart that shows aspects of the STA in accordance with the second technique of the present disclosure.

### DETAILED DESCRIPTION

As discussed above, device provisioning protocol (DPP) allows onboarding of devices (e.g., enrolling the device onto the wireless network) using different methods (e.g., QR-code, NFC, Wi-Fi Aware, Wi-Fi Direct, etc.) that may be classified as either out-of-band techniques or in-band techniques. Due to the vulnerabilities of out-of-band techniques where bootstrapping information (e.g., sensitive information used to facilitate authentication) is broadcasted over the Wi-Fi network, devices employing out-of-band techniques may be susceptible to a malicious attack by third-party device that may intercept the sensitive bootstrapping information for non-legitimate purposes. In some examples, the third-party device may use the captured bootstrapping information to authenticate and provision itself to the enrollee (e.g., DPP-AP or other DPP devices). For purpose of this disclose, the term DPP enabled device refers to either DPP-AP and/or DPP-STA. Thus, the terms “DPP-AP” or “DPP-STA” may be used interchangeably for purpose of this disclosure to refer to any device that is capable of implementing device provisioning protocol. The problem with the conventional systems relying on DPP techniques is rooted in the fact that the enrollee is generally unaware of the bootstrapping method selected by the provisioning device (e.g., STA). As such, the enrollee is unable to distinguish between the various bootstrapping methods.

Aspects of the present disclosure solve the above-identified problem by implementing techniques that allow an enrollee (e.g., DPP-AP or other DPP devices) to be informed of the bootstrapping method selected by the device (e.g., STA) when initiating onboarding. In accordance with a first technique, each bootstrapping method is associated with different static (or “predetermined”) bootstrapping credentials (e.g., Elliptic Curve Diffie-Hellman (ECDH) key pairs). The enrollee may maintain a data structure that associates the key pairs (or “authentication key”) with each bootstrapping method. By utilizing the bootstrapping information carried in the DPP authentication request transmitted by the device, the enrollee may derive the authentication key that may further “unlock” or “unwrap” additional sensitive bootstrapping information included in the DPP authentication request. Because the bootstrapping information may be protected by a private key, a third-party device may be unable to easily capture the sensitive bootstrapping information broadcasted over the WLAN.

In accordance with a second technique, instead of associating each bootstrapping method with a predetermined bootstrapping credentials, aspects of the present disclosure may assign a random identification to each bootstrapping method that may be verified by the enrollee. For example, if the device selects QR-code as a bootstrapping method, a random identification (ID) may be added to the QR-code format and printed in the QR-code. Accordingly, the hashing value for the device may be calculated based on the random ID that may be included in the DPP authentication request.

Various concepts will now be described more fully hereinafter with reference to the accompanying drawings. These concepts may, however, be embodied in many different forms by those skilled in the art and should not be construed as limited to any specific structure or function presented herein. Rather, these concepts are provided so that this disclosure will be thorough and complete, and will fully convey the scope of these concepts to those skilled in the art. The detailed description may include specific details. However, it will be apparent to those skilled in the art that these concepts may be practiced without these specific details. In some instances, well known structures and components are shown in block diagram form in order to avoid obscuring the various concepts presented throughout this disclosure.

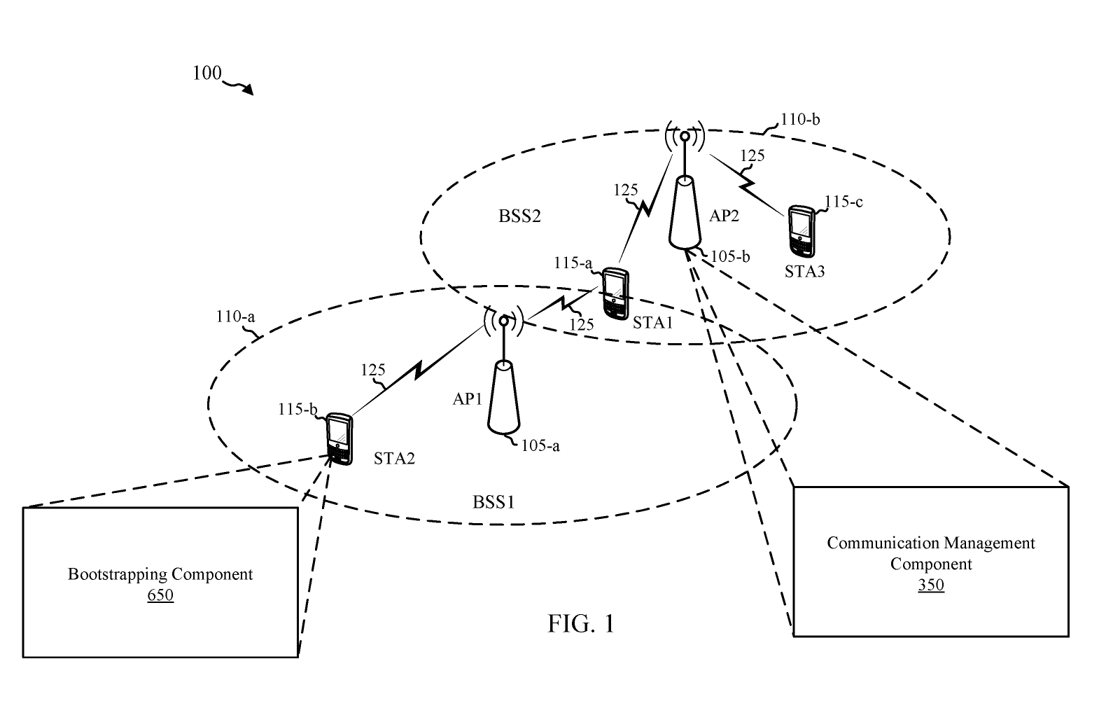

FIG. 1 is a conceptual diagram 100 illustrating an example of a wireless local area network (WLAN) deployment in connection with various techniques described herein. The WLAN may include one or more access points (APs) 105 and one or more mobile stations (STAs) 115 associated with a respective AP. In some examples, the one or more APs 105 may be an example of a DPP-AP 105 (or enrollee). Although the DPP-AP 105 is illustrated as an enrollee, it should be appreciated that in some examples another device (e.g., STA 115) may also be an enrollee of a provisioning device. Thus, in some examples, a first STA 115 may provision a second STA 115 (e.g., DPP Device). In this example, there are two APs deployed: AP1 105-a in basic service set 1 (BSS1) and AP2 105-b in BSS2, which may be referred to as an OBSS. AP1 105-a is shown as having at least two associated STAs (STA1 115-a and STA2 115-b) and coverage area 110-a, while AP2 105-b is shown having at least two associated STAs (STA1 115-a and STA3 115-c) and coverage area 110-b. The STAs and AP associated with a particular BSS may be referred to as members of that BSS. In the example of FIG. 1, the coverage area of AP1 105-a may overlap part of the coverage area of AP2 105-b such that STA1 115-a may be within the overlapping portion of the coverage areas. The number of BSSs, APs, and STAs, and the coverage areas of the APs described in connection with the WLAN deployment of FIG. 1 are provided by way of illustration and not of limitation.

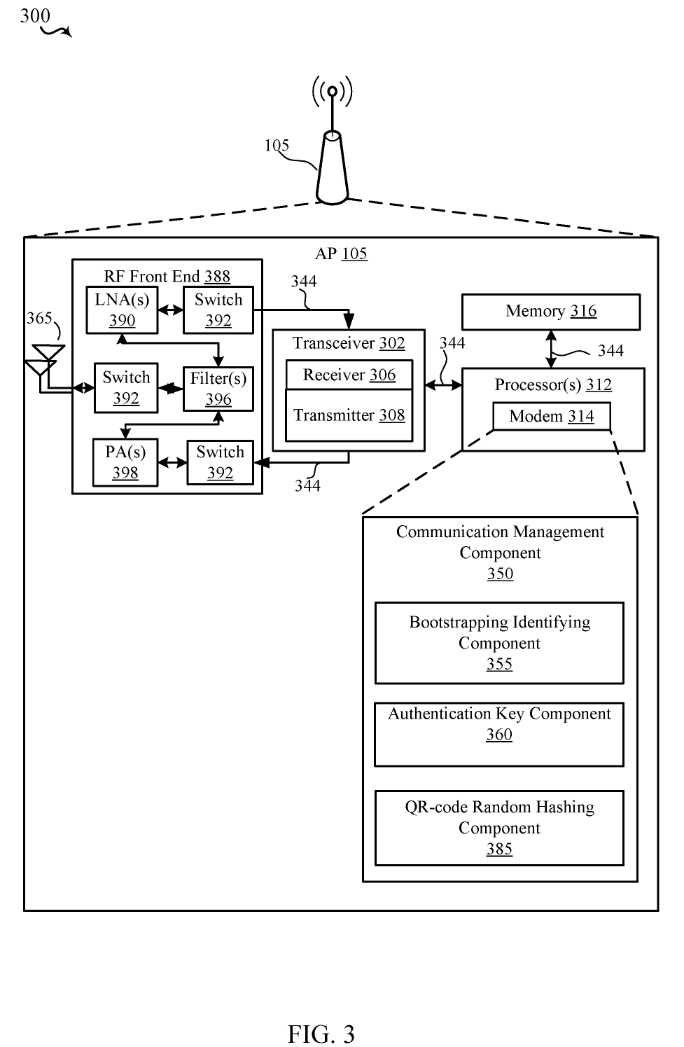

In some examples, the APs (e.g., AP1 105-a and AP2 105-b) shown in FIG. 1 are generally fixed terminals that provide backhaul services to STAs 115 within its coverage area or region. In some applications, however, the AP may be a mobile or non-fixed terminal. The AP 105 may include a communication management component 350 (see FIG. 3) for decoding at least portion of the DPP authentication request received from the STA 115 to identify the type of bootstrapping method employed (or selected) by the STA in initiating the onboarding process (e.g., the authentication protocol process). In some examples, each bootstrapping method (e.g., QR-code, NFC, Wi-Fi Aware, Wi-Fi Direct, etc.) may be associated with a unique predetermined bootstrapping key (e.g., ECDH key pair). The communication management component 350 may utilize the information regarding the bootstrapping method to unlock or unwrap protected information included in authentication request transmitted by the STA 115.

The STAs (e.g., STA1 115-a, STA2 115-b and STA3 115-c) shown in FIG. 1, which may be fixed, non-fixed, or mobile terminals, utilize the backhaul services of their respective AP to connect to a network, such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, or any other suitable terminology. The various concepts described throughout this disclosure are intended to apply to all suitable wireless apparatus regardless of their specific nomenclature.

Each of STA1 115-a, STA2 115-b, and STA3 115-c may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network. The STA 115 may include the bootstrapping component 650 for selecting a bootstrapping method from a plurality of bootstrapping methods available to the device to initiate authentication protocol procedures. In some examples, the bootstrapping methods may include, but not limited to QR-Code, NFC, BTLE, Wi-Fi Aware, Wi-Fi Direct etc.

Each of AP1 105-a and AP2 105-b can include software applications and/or circuitry to enable associated STAs to connect to a network via communications link 125. The APs can send frames or packets to their respective STAs and receive frames or packets from their respective STAs to communicate data and/or control information (e.g., signaling). Each of AP1 105-a and AP2 105-b can establish a communications link 125 with an STA that is within the coverage area of the AP. Communications link 125 can comprise communications channels that can enable both uplink and downlink communications. When connecting to an AP, an STA can first authenticate itself with the AP and then associate itself with the AP. Once associated, a communications link 125 may be established between the AP 105 and the STA 115 such that the AP 105 and the associated STA 115 may exchange frames or messages through a direct communications channel. It should be noted that the wireless communication system, in some examples, may not have a central AP (e.g., AP 105), but rather may function as a peer-to-peer network between the STAs. Accordingly, the functions of the AP 105 described herein may alternatively be performed by one or more of the STAs 115.

In some examples, a STA (e.g., STA1 115-a) may be in vicinity of a plurality of APs (e.g., first AP 105-a that may be a serving AP) and a second AP 105-b that may be a potential target AP. At the edge of the coverage area 110-a of the first AP 105-a, the signal quality between the first AP 105-a and the STA1 115-a may deteriorate. In such situations, the STA 115-a may be better served by the second AP 105-b. However, conventional techniques where the STA 115-a may not support IEEE 802.11k/v functionality, the STA 115-a may not be able to communicate to the first AP 105-a the signal metric information between the second AP 105-b and the STA 115-a. Further, because the STA 115-a may maintain its connection with the first AP 105-a, the STA 115-a may suffer with signal quality.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for performing operations based on modifications and enhancements to dynamic sensitivity control may be applicable to any suitable wireless network regardless of the coverage range and the wireless access protocols utilized.

In some aspects, one or more APs (105-a and 105-b) may transmit on one or more channels (e.g., multiple narrowband channels, each channel including a frequency bandwidth) a beacon signal (or simply a “beacon”), via a communications link 125 to STA(s) 115 of the wireless communication system, which may help the STA(s) 115 to synchronize their timing with the APs 105, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, wireless devices (e.g., STA 115 and/or AP 105) may, in order to increase reuse of the spectrum, transmit on top of transmissions coming from an OBSS and refrain from transmitting on top of transmissions coming from the same BSS (also known as in-BSS). To enable a wireless device to determine whether a transmission is from the same BSS as the wireless device or from an OBSS, some packets may have a color code/information that identifies the BSS from which the packets originated, in some cases the BSSID field is also included along with BSS color. Color code/information may be a BSS identifier (BSSID) or a partial BSSID or separate value advertised by the AP. When the wireless device receives a packet with color information, the wireless device may determine if the packet is associated with the same BSS as the wireless device, and may therefore defer transmissions, or if the packet is associated with an OBSS, in which case the wireless device may reuse the spectrum.

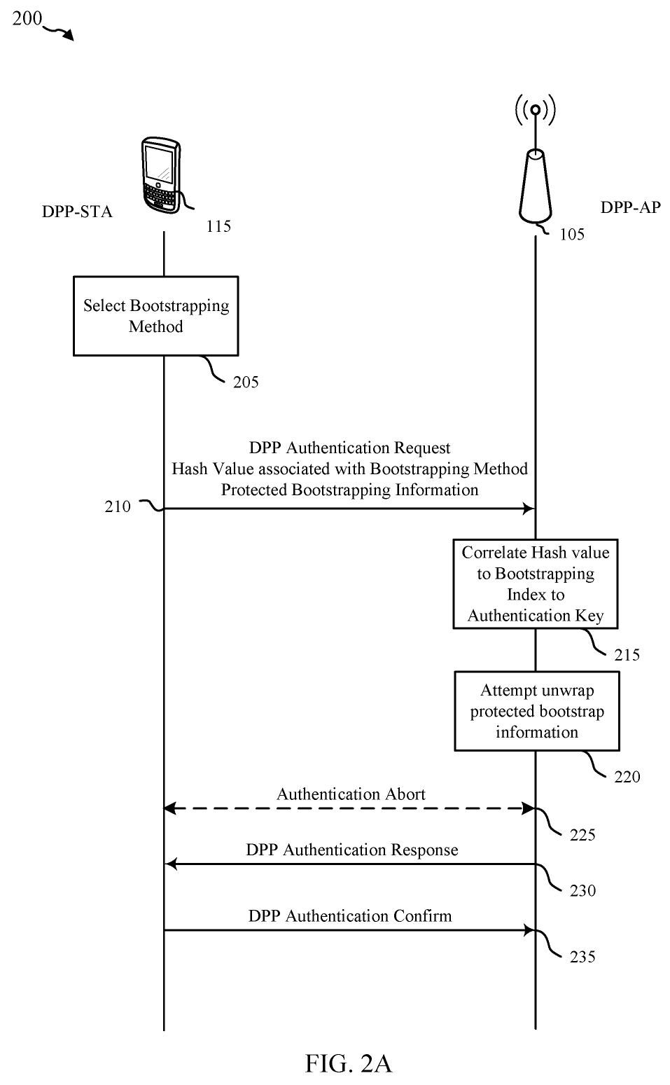

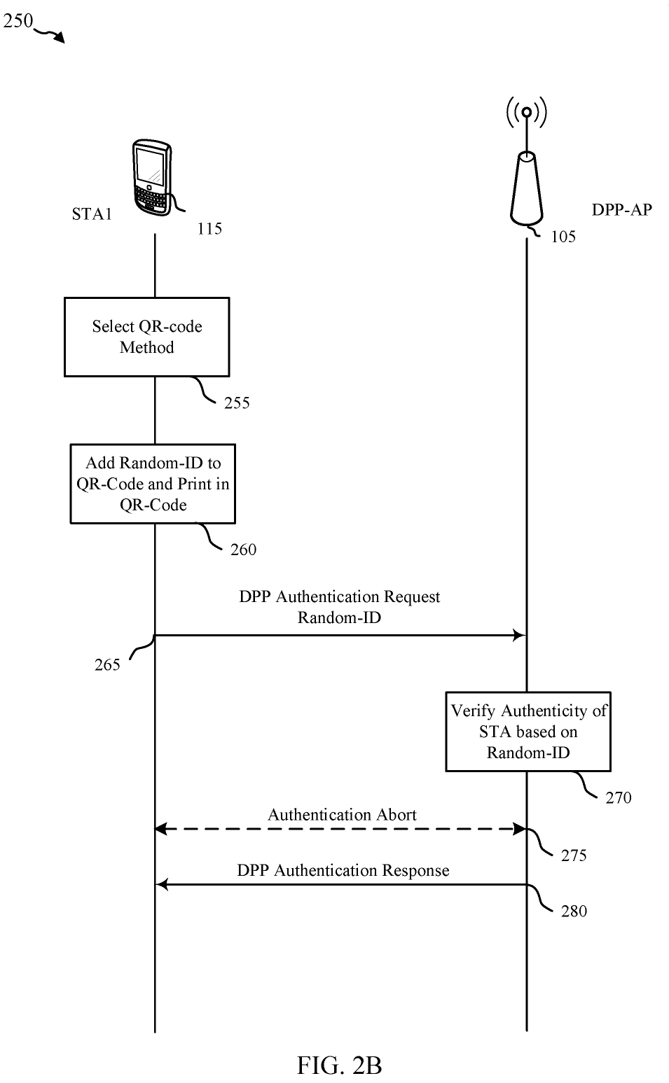

FIG. 2A is a call flow diagram 200 for provisioning a DPP-STA 115 to the DPP-AP 105 in accordance with the first technique disclosed herein based on one or more bootstrapping methods available to the STA 115. Although FIG. 2A illustrates a STA 115 transmitting the DPP authentication request to the DPP-AP 105, it should be appreciated that the authentication may be performed between any two DPP enabled devices (e.g., STA or AP). Thus, in some instances, the authentication process described herein may be conducted between DPP-STA to DPP-AP, DPP-STA to DPP-STA, or DPP-AP to DPP-AP.

In some examples, the STA 115 may be an example of a STA 115 discussed with reference to FIG. 1. Similarly, the AP 105 may be example of one or more APs 105 described with reference to FIG. 1 above. Additionally, in some examples, instead of an AP 105, another device (e.g., DPP-device) may also perform one or more methods described in the present application.

At 205, the provisioning device (e.g., STA 115) may select a bootstrapping method from a plurality of bootstrapping methods available to the STA 115. As discussed above, DPP allows initiating device onboarding with different bootstrapping methods that include QR-code, NFC, BTLE, Wi-Fi Aware, Wi-Fi Direct etc. Each of the methods may be classified as either out-of-band techniques or in-band techniques. As noted, in-band techniques are vulnerable to malicious attacks that my capture sensitive bootstrapping information transmitted by the provisioning device (e.g., STA1 115).

At 210, the STA 115 may generate a DPP authentication request (also referred simply as an “authentication request”) that includes information that informs the DPP-AP 105 of the bootstrapping method selected by the STA 115 and additionally includes protected bootstrapping information that may be used to authenticate the STA 115. In some examples, the bootstrapping information may be associated with a hash value calculated by the DPP-STA 115. In such instance, the DPP authentication request may include the hash value associated with the bootstrapping information. The DPP-AP 105 and the STA 115 may share an authentication key structure that allows the DPP-AP to derive an authentication key based on the bootstrapping method information included in the DPP authentication request. The derived authentication key unlocks or unwraps the protected bootstrapping information that may be hidden or protected from malicious interference from third-party devices. In some examples, the STA 115 may signal the selected bootstrapping method by including a value (e.g., index) that is associated with each bootstrapping method.

At 215, upon receiving the DPP authentication request, the DPP-AP 105 may correlate, map, associate, or link the hash value to a bootstrapping method selected by the DPP-STA 115. In some examples, correlating, mapping, associating, or linking may include mapping the hash value and the bootstrapping index associated with the bootstrapping method with each unique authentication key. At 220, the DPP-AP 105 may attempt to unlock the protected bootstrap information using the derived authentication key. If the DPP-AP 105 fails to successfully unlock the protected bootstrapping information, the DPP-AP 105, at 225, may abort the authentication protocol with the STA 115. However, if the DPP-AP 105 successfully unlocks the protected bootstrapping information, the DPP-AP 105 may authenticate the STA 115 and transmit a DPP authentication response 230 to the STA 115. The DPP authentication response 230 may indicate that server has authenticated and attached the STA by issuing a certificate to the STA. In response, the STA 115, at 235, may transmit a DPP authentication confirm message to the DPP-AP 105.

FIG. 2B is a call flow diagram 250 for provisioning a STA 115 to the DPP-AP 105 in accordance with the second technique disclosed herein. As with FIG. 2A above, the STA 115 may be an example of a STA 115 and the AP 105 may be example of one or more APs 105 described with reference to FIG. 1 above.

At 255, the STA 115 may select the QR-code bootstrapping method to initiate device provisioning procedure with the DPP-AP 105. At 260, the STA 115 may add a random identification (ID) to the QR-code and print the random-ID to the QR-code. At 265, the STA 115 may transmit the DPP authentication request to the DPP-AP 105 that includes the random ID. Upon scanning the QR-code, the DPP-AP 105, at 270, may verify the authenticity of the STA 115 by calculating a hash value based on the random-ID included in the DPP authentication request and determining whether the hash value corresponds with an authenticated STA. If the hash value fails to correspond, the DPP-AP 105 may, at 275, abort the authentication process. However, if the calculated hash value succeeds in corresponding to the authentic STA 115, the DPP-AP 105, at 280, may transmit DPP authentication response to the STA 115.

FIG. 3 describes hardware components and subcomponents of a DPP enabled AP 105 for implementing one or more methods described herein in accordance with various aspects of the present disclosure. The AP 105 may be an example of a DPP-AP or DPP-Device providing authentication to a provisioning device (e.g., STA).

One example of an implementation of AP 105 may include a variety of components, including components such as one or more processors 312 and memory 316 and transceiver 302 in communication via one or more buses 344, which may operate in conjunction with communication management component 350 to enable one or more of the functions described herein related to including one or more methods of the present disclosure. Further, the one or more processors 312, modem 314, memory 316, transceiver 302, RF front end 388 and one or more antennas 365, may be configured to support voice and/or data calls (simultaneously or non-simultaneously) in one or more radio access technologies.

In an aspect, the one or more processors 312 can include a modem 314 that uses one or more modem processors. The various functions related to communication management component 350 may be included in modem 314 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 314 associated with communication management component 350 may be performed by transceiver 302.

Also, memory 316 may be configured to store data used herein and/or local versions of applications or communication management component 350 and/or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining communication management component 350 and/or one or more of its subcomponents, and/or data associated therewith, when AP 105 is operating at least one processor 312 to execute communication management component 350 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one STA 115 or other APs 105. For example, the receiver 306 may receive a monitoring request from a serving AP. Additionally, receiver 306 may process such received signals, and also may obtain measurements of the signals, such as, but not limited to, Ec/Io, SNR, RSRP, RSSI, etc. Transmitter 308 may include hardware, firmware, and/or software code executable by a processor for transmitting data, the code comprising instructions and being stored in a memory (e.g., computer-readable medium). A suitable example of transceiver 302 may including, but is not limited to, an RF transmitter.

Moreover, in an aspect, AP 105 may include RF front end 388, which may operate in communication with one or more antennas 365 and transceiver 302 for receiving and transmitting radio transmissions, for example, wireless communications transmitted by at least one other AP 105 or wireless transmissions transmitted by STA 115. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 688 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that AP 105 can communicate with, for example, one or more STAs 115 or one or more cells associated with one or more AP 105. In an aspect, for example, modem 314 can configure transceiver 602 to operate at a specified frequency and power level based on the UE configuration of the AP 105 and the communication protocol used by modem 314.

In an aspect, modem 314 can be a multiband-multimode modem, which can process digital data and communicate with transceiver 302 such that the digital data is sent and received using transceiver 302. In an aspect, modem 314 can be multiband and be configured to support multiple frequency bands for a specific communications protocol. In an aspect, modem 414 can be multimode and be configured to support multiple operating networks and communications protocols. In an aspect, modem 314 can control one or more components of AP 105 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on configuration information associated with AP 105 as provided by the network during cell selection and/or cell reselection.

The communication management component 350 may include a bootstrapping identifying component 355 for decoding at least portion of the DPP authentication request received from the STA to identify the type of bootstrapping method employed (or selected) by the STA in initiating the onboarding process (e.g., the authentication protocol process). In some examples, each bootstrapping method (e.g., QR-code, NFC, Wi-Fi Aware, Wi-Fi Direct, etc.) may be associated with a unique predetermined bootstrapping key (e.g., ECDH key pair).

The authentication key component 360 may manage the authentication keys such that the enrollee (e.g., AP 105) may maintain a data structure in the memory 316 that correlates each of the plurality of bootstrapping methods available to the STA with a plurality of authentication keys. For example, a first bootstrapping method (e.g., QR-code) may be assigned a first index (e.g., index=‘0’) and a second bootstrapping method (e.g., Wi-Fi Direct) may be assigned a second index (e.g., index=‘1’). Each of the bootstrapping method indices may correspond with a unique “authentication key”. The authentication key may be used by the DPP-AP 105 to unlock or unwrap another portion of the authentication message that may be protected or locked (e.g., sensitive bootstrapping information provided by the STA 115 for authentication). Thus, in order to access the protected bootstrapping information, the DPP-AP 105 may be required to derive the correct authentication key that unwraps the information in the DPP authentication request. If the enrollee derives an incorrect authentication key and cannot unlock the protected bootstrapping information, the communication management component 350 may abort the authentication protocol procedures with the requesting STA 115.

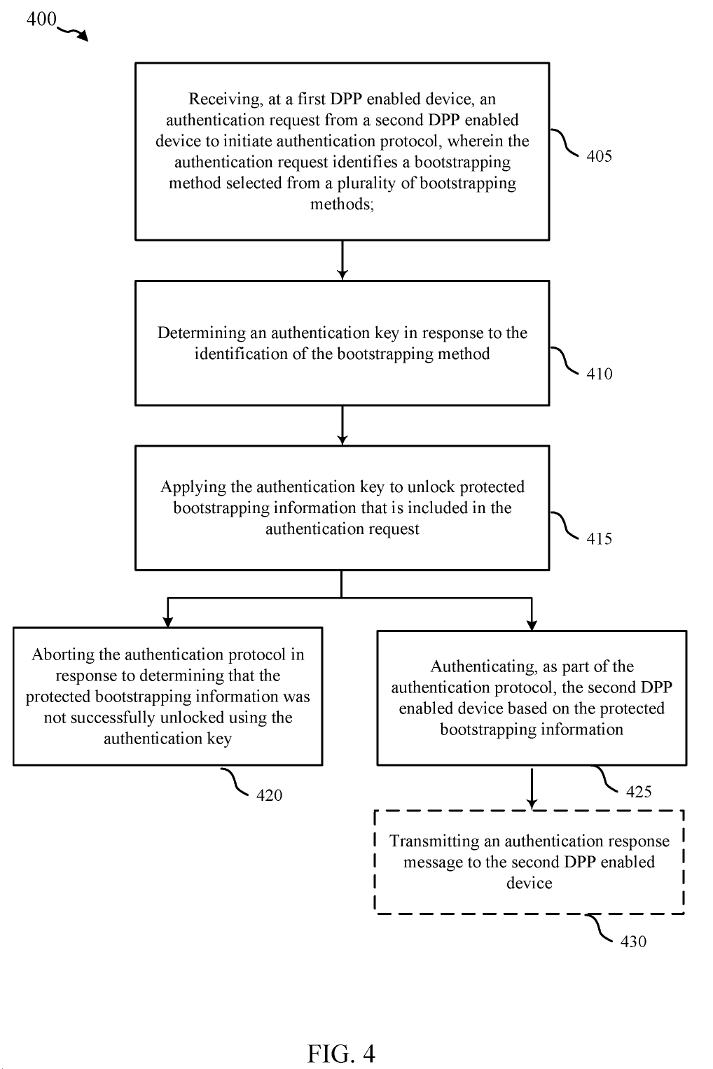

FIG. 4 is a flowchart conceptually illustrating an example of a method 400 of wireless communication implemented by a DPP enabled devices, in accordance with aspects of the present disclosure. For clarity, the method 400 is described below with reference to any DPP enabled device (e.g., AP 105 or STA 115 of FIGS. 1, 2A, 2B, and 3).

At block 405, the method 400 may include receiving, at a first DPP enabled device, an authentication request from a wireless STA to initiate an authentication protocol. The authentication request may identify a bootstrapping method selected from a plurality of bootstrapping methods supported by the STA. In some examples, the first DPP enabled device may include a hash value associated with the selected bootstrapping method with the authentication request. Aspects of block 405 may be performed by transceiver 302 described with reference to FIG. 3.

At block 410, the method 400 may include determining an authentication key in response to the identification of the bootstrapping method. In some examples, determining the authentication key may include correlating each of the plurality of bootstrapping methods supported (or available) to the STA with a plurality of authentication keys (e.g., QR-Code may be correlated to a first authentication key that is derived from the first index value and Wi-Fi Direct may be correlated to a second authentication key that is derived from the second index value) based on a hash value calculated by the DPP enabled devices. Thereafter, based on at least decoding of the portion of the DPP authentication request, the DPP-AP may identify the authentication key from the plurality of authentication key by referencing the data structure in the memory of the DPP-AP that corresponds with the bootstrapping method selected by the STA and informed in the authentication request. Aspects of block 410 may be performed by authentication key component 360 described with reference to FIG. 3.

At block 415, the method 400 may include applying the authentication key to unlock protected bootstrapping information that is included in the authentication request. If the DPP-AP was unable or unsuccessful to unlock the protected bootstrapping information (e.g., due to incorrect authentication key calculation), the DPP-AP may proceed to block 420 in order to abort the authentication protocol procedures and inform the STA of the rejected authentication. However, if the protected bootstrapping information was successfully unlocked, the method 400 may proceed to block 425 to authenticate, as part of the authentication protocol, the STA by utilizing the unwrapped bootstrapping information and optionally transmit, at block 430, an authentication response message to the STA. Thus, to that end, the DPP-AP 105 after applying the authentication key to unlock protected bootstrapping information may first determine whether the protected bootstrapping information was successfully unlocking using the authentication key as part of the authentication protocol procedure. Aspects of block 415, 420, and 425 may be performed by the communication management component 350 described with reference to FIG. 3.

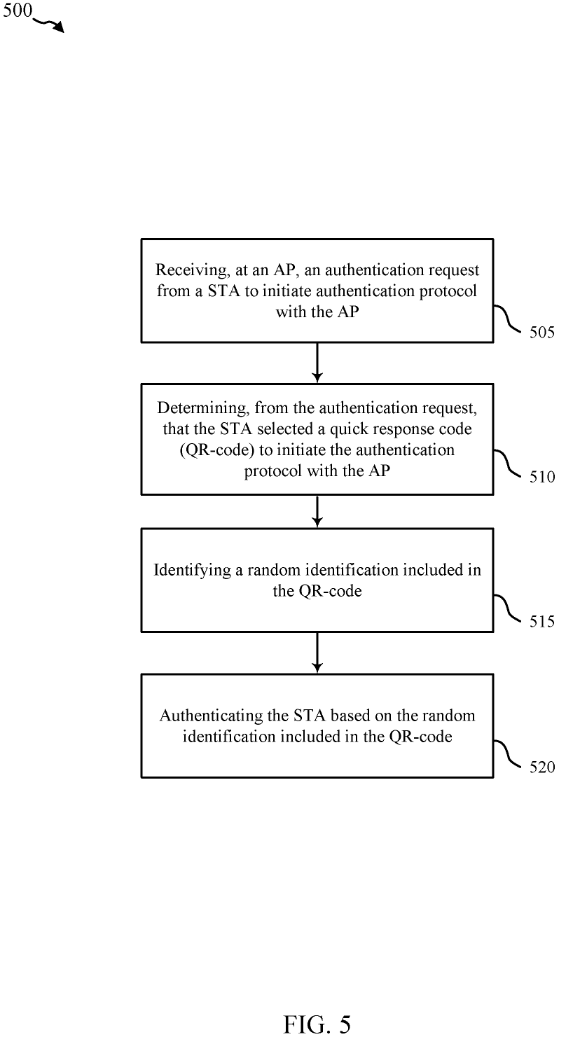

FIG. 5 is a flowchart conceptually illustrating an example of a method 500 of wireless communication implemented by a DPP-AP or another DPP-device, in accordance with aspects of the present disclosure. For clarity, the method 500 is described below with reference to AP 105 of FIGS. 1, 2A, 2B, and 3.

At block 505, the method may include receiving, at an AP, an authentication request from a STA to initiate an authentication protocol with the AP. Aspects of the block 505 may be performed by the transceiver 302 described with reference to FIG. 3.

At block 510, the method may include determining, from the authentication request, that the STA selected a QR-code bootstrapping method to initiate the authentication protocol with the AP. Aspects of block 510 may be performed by bootstrapping identifying component 355 described with reference to FIG. 3.

At block 515, the method may include identifying a random identification included (and printed) in the QR-code. Aspects of block 515 may be performed by QR-code random hashing component 385 described with reference to FIG. 3.

At block 520, the method may include authenticating the STA based on the random identification included in the QR-code. In some examples, authenticating the STA may comprise calculating a hash value in response to the random identification included in the QR-code and authenticating the STA in response to the hash value. If the STA fails to be authenticated using the hash value, the DPP-AP 105 may abort the authentication protocol procedure. However, if the STA is authenticated using the hash value, the DPP-AP 105 may transmit an authentication response message to the STA confirming the authentication. Aspects of block 520 may also be performed by QR-code random hashing component 385 described with reference to FIG. 3.

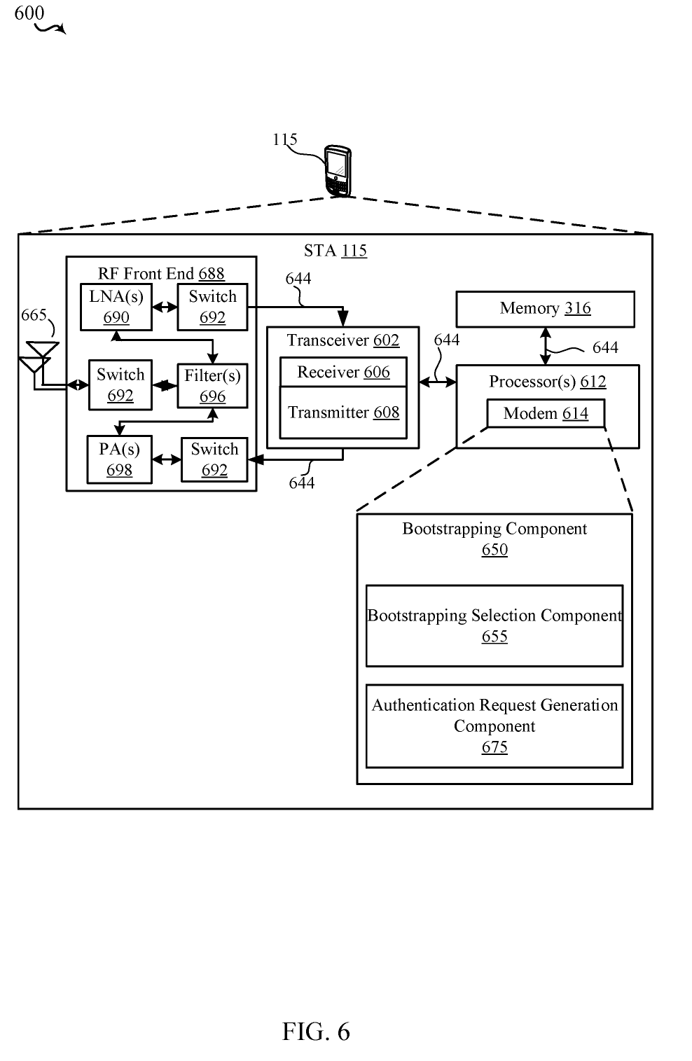

FIG. 6 describes hardware components and subcomponents of a DPP enabled STA 115 for implementing one or more methods described herein in accordance with various aspects of the present disclosure. The STA 115 may be an example of a device attempting to provision the DPP-AP or another DPP-device.

One example of an implementation of STA 115 may include a variety of components, including components such as one or more processors 612 and memory 616 and transceiver 602 in communication via one or more buses 644, which may operate in conjunction with bootstrapping component 650 to enable one or more of the functions described herein related to including one or more methods of the present disclosure. Further, the one or more processors 612, modem 614, memory 616, transceiver 602, RF front end 688 and one or more antennas 665, may be configured to support voice and/or data calls (simultaneously or non-simultaneously) in one or more radio access technologies.

In an aspect, the one or more processors 612 can include a modem 614 that uses one or more modem processors. The various functions related to bootstrapping component 650 may be included in modem 614 and/or processors 612 and, in an aspect, can be executed by a single processor, while in other aspects, different ones of the functions may be executed by a combination of two or more different processors. For example, in an aspect, the one or more processors 612 may include any one or any combination of a modem processor, or a baseband processor, or a digital signal processor, or a transmit processor, or a receiver processor, or a transceiver processor associated with transceiver 602. In other aspects, some of the features of the one or more processors 612 and/or modem 614 associated with bootstrapping component 650 may be performed by transceiver 602.

Also, memory 616 may be configured to store data used herein and/or local versions of applications or bootstrapping component 650 and/or one or more of its subcomponents being executed by at least one processor 612. Memory 616 can include any type of computer-readable medium usable by a computer or at least one processor 612, such as random access memory (RAM), read only memory (ROM), tapes, magnetic discs, optical discs, volatile memory, non-volatile memory, and any combination thereof. In an aspect, for example, memory 616 may be a non-transitory computer-readable storage medium that stores one or more computer-executable codes defining bootstrapping component 650 and/or one or more of its subcomponents, and/or data associated therewith, when STA 115 is operating at least one processor 612 to execute bootstrapping component 650 and/or one or more of its subcomponents.

Transceiver 602 may include at least one receiver 606 and at least one transmitter 608. Receiver 606 may include hardware, firmware, and/or software code executable by a processor for receiving data, the code comprising instructions and being stored in a memory (e.g., computer-readable medium). Receiver 606 may be, for example, a radio frequency (RF) receiver. In an aspect, receiver 606 may receive signals transmitted by at least one STA 115 or other APs 105. Additionally, receiver 606 may process such received signals, and also may obtain measurements of the signals, such as, but not limited to, Ec/Io, SNR, RSRP, RSSI, etc. Transmitter 608 may include hardware, firmware, and/or software code executable by a processor for transmitting data, the code comprising instructions and being stored in a memory (e.g., computer-readable medium). A suitable example of transceiver 602 may including, but is not limited to, an RF transmitter.

Moreover, in an aspect, STA 115 may include RF front end 688, which may operate in communication with one or more antennas 665 and transceiver 602 for receiving and transmitting radio transmissions, for example, wireless communications transmitted by at least one other AP 105 or wireless transmissions transmitted by STA 115. RF front end 688 may be connected to one or more antennas 665 and can include one or more low-noise amplifiers (LNAs) 690, one or more switches 692, one or more power amplifiers (PAs) 698, and one or more filters 696 for transmitting and receiving RF signals.

In an aspect, LNA 690 can amplify a received signal at a desired output level. In an aspect, each LNA 690 may have a specified minimum and maximum gain values. In an aspect, RF front end 688 may use one or more switches 692 to select a particular LNA 690 and its specified gain value based on a desired gain value for a particular application.

Further, for example, one or more PA(s) 698 may be used by RF front end 688 to amplify a signal for an RF output at a desired output power level. In an aspect, each PA 698 may have specified minimum and maximum gain values. In an aspect, RF front end 688 may use one or more switches 692 to select a particular PA 698 and its specified gain value based on a desired gain value for a particular application.

Also, for example, one or more filters 696 can be used by RF front end 688 to filter a received signal to obtain an input RF signal. Similarly, in an aspect, for example, a respective filter 696 can be used to filter an output from a respective PA 698 to produce an output signal for transmission. In an aspect, each filter 696 can be connected to a specific LNA 690 and/or PA 698. In an aspect, RF front end 688 can use one or more switches 692 to select a transmit or receive path using a specified filter 696, LNA 690, and/or PA 698, based on a configuration as specified by transceiver 602 and/or processor 612.

As such, transceiver 602 may be configured to transmit and receive wireless signals through one or more antennas 665 via RF front end 688. In an aspect, transceiver may be tuned to operate at specified frequencies such that STA 115 can communicate with, for example, one or more STA 115 or one or more cells associated with one or more AP 105. In an aspect, for example, modem 614 can configure transceiver 602 to operate at a specified frequency and power level based on the UE configuration of the AP 105 and the communication protocol used by modem 614.

In an aspect, modem 614 can be a multiband-multimode modem, which can process digital data and communicate with transceiver 602 such that the digital data is sent and received using transceiver 602. In an aspect, modem 614 can be multiband and be configured to support multiple frequency bands for a specific communications protocol. In an aspect, modem 614 can be multimode and be configured to support multiple operating networks and communications protocols. In an aspect, modem 614 can control one or more components of STA 115 (e.g., RF front end 688, transceiver 602) to enable transmission and/or reception of signals from the network based on a specified modem configuration. In an aspect, the modem configuration can be based on the mode of the modem and the frequency band in use. In another aspect, the modem configuration can be based on configuration information associated with STA 115 as provided by the network during cell selection and/or cell reselection.

The bootstrapping component 650 may include a bootstrapping selection component 655 for selecting a bootstrapping method from a plurality of bootstrapping methods available to the device to initiate authentication protocol procedures. In some examples, the bootstrapping methods may include, but not limited to QR-Code, NFC, BTLE, Wi-Fi Aware, Wi-Fi Direct etc. Each of the one or more bootstrapping methods may be classified as either out-of-band techniques or in-band techniques. In some examples, the bootstrapping component 650 may further include authentication request generation component 675 for generating a DPP authentication request that includes information regarding the selected bootstrapping method (e.g., bootstrapping index that may be shared with the DPP-AP). In some examples, where the selected bootstrapping method is a QR-code, the authentication request generation component 675 may add a random identification to the QR-code format and the print the random-ID to the QR-code that is read by the DPP-AP. Based on the scanned QR-code, the DPP-AP may be able to calculate a hashing value of the STA in order to authenticate the request.

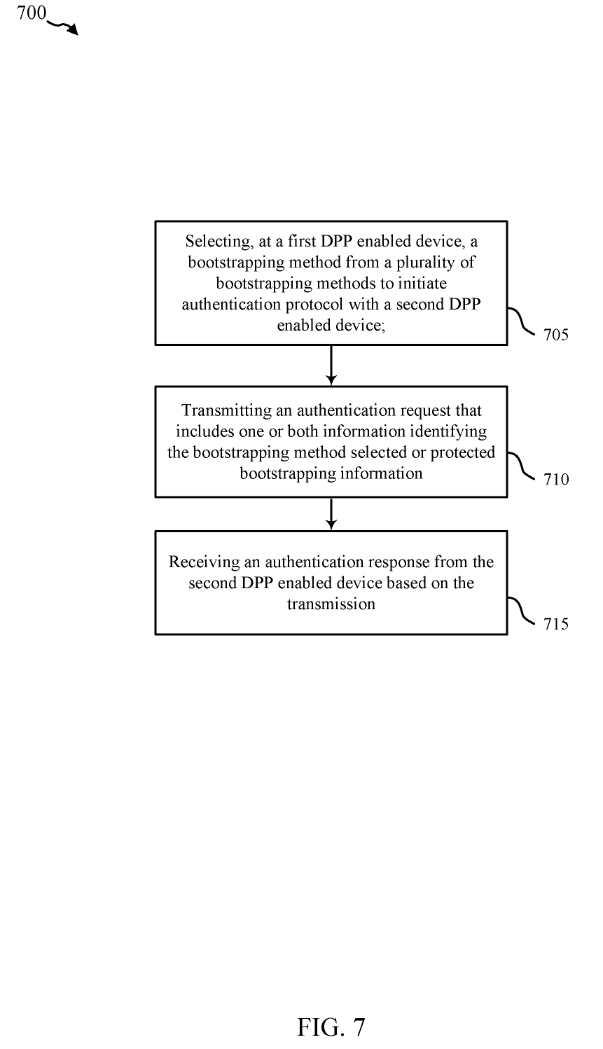

FIG. 7 is a flowchart conceptually illustrating an example of a method 700 of wireless communication implemented by a DPP enabled device (e.g., STA or AP) in accordance with aspects of the present disclosure. For clarity, the method 700 is described below with reference to DPP enabled devices (e.g., STAs 115 or AP 105) of FIGS. 1, 2A-2B, and 6.

At block 705, the method 700 may include selecting, at a first DPP enabled device, a bootstrapping method from a plurality of bootstrapping methods to initiate an authentication protocol with a second DPP enabled device. Aspects of the block 705 may be performed by the bootstrapping selection component 655 described with reference to FIG. 6.

At block 710, the method 700 may include transmitting an authentication request that includes one or both information identifying the bootstrapping method selected or protected bootstrapping information. Aspects of the block 710 may be performed by authentication request generation component 675 and transceiver 602 described with reference to FIG. 6.

At block 715, the method 700 may include receiving an authentication response from the second DPP enabled device based on the transmission. Aspects of the block 715 may also be performed by the transceiver 602 described with reference to FIG. 6.

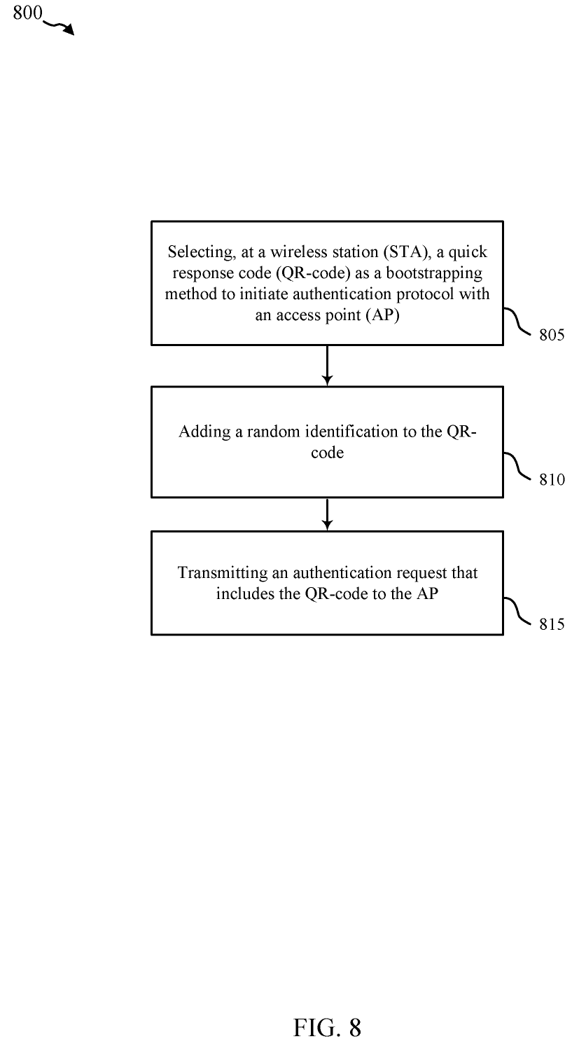

FIG. 8 is a flowchart conceptually illustrating a second example of a method 800 of wireless communication implemented by a STA in accordance with aspects of the present disclosure. For clarity, the method 800 is described below with reference to STA 115 of FIGS. 1, 2A-2B, and 6.

At block 805, the method 800 may include selecting, at a wireless STA, a QR-code as a bootstrapping method to initiate an authentication protocol with an AP. Aspects of the block 805 may be performed by the bootstrapping selection component 655 described with reference to FIG. 6.

At block 810, the method 800 may include adding a random identification to the QR-code based on the selection. Aspects of the block 810 may be performed by the authentication request generation component 675 described with reference to FIG. 6.

At block 815, the method 800 may include transmitting an authentication request that includes the QR-code to the AP. Aspects of the block 815 may also be performed by the transceiver 602 described with reference to FIG. 6.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A method for wireless communication, comprising:
receiving, at a first device provisioning protocol (DPP) enabled device, an authentication request from a second DPP enabled device to initiate an authentication protocol, wherein the authentication request identifies a bootstrapping method selected from a plurality of bootstrapping methods;
determining an authentication key in response to the identification of the bootstrapping method; and
applying the authentication key to unlock protected bootstrapping information that is included in the authentication request.

2. The method of claim 1, wherein the bootstrapping method selected from the plurality of bootstrapping methods is associated with a hash value included in the authentication request.

3. The method of claim 1, further comprising:
aborting the authentication protocol in response to determining that the protected bootstrapping information was not successfully unlocked using the authentication key.

4. The method of claim 1, further comprising:
determining that the protected bootstrapping information was successfully unlocked using the authentication key;
authenticating, as part of the authentication protocol, the second DPP enabled device based on the protected bootstrapping information; and
transmitting an authentication response message to the second DPP enabled device.

5. The method of claim 1, wherein determining the authentication key in response to the identification of the bootstrapping method comprises:
correlating each of the plurality of bootstrapping methods with a plurality of authentication keys; and
identifying the authentication key from the plurality of authentication keys that corresponds with the bootstrapping method identified in the authentication request.

6. The method of claim 1, wherein the first DPP enabled device and the second DPP enabled device is one of a wireless station or access point.

7. A device provisioning protocol (DPP) enabled device for wireless communication, comprising:
a processor; and
a memory coupled to the processor, wherein the memory includes instructions executable by the processor to:
receive, at a first DPP enabled device, an authentication request to initiate an authentication protocol with a second DPP enabled device, wherein the authentication request identifies a bootstrapping method selected from a plurality of bootstrapping methods;
determine an authentication key in response to the identification of the bootstrapping method; and
apply the authentication key to unlock protected bootstrapping information that is included in the authentication request.

8. The DPP enabled device of claim 7, wherein the bootstrapping method selected from the plurality of bootstrapping methods is associated with a hash value included in the authentication request.

9. The DPP enabled device of claim 7, wherein the instructions are further executable by the processor to:
abort the authentication protocol in response to determining that the protected bootstrapping information was not successfully unlocked using the authentication key.

10. The DPP enabled device of claim 7, wherein the instructions are further executable by the processor to:
determine that the protected bootstrapping information was successfully unlocked using the authentication key;
authenticate, as part of the authentication protocol, the second DPP enabled device based on the protected bootstrapping information; and
transmit an authentication response message to the second DPP enabled device.

11. The DPP enabled device of claim 7, wherein determining the authentication key in response to the identification of the bootstrapping method comprises:
correlating each of the plurality of bootstrapping methods with a plurality of authentication keys; and
identifying the authentication key from the plurality of authentication keys that corresponds with the bootstrapping method identified in the authentication request.

12. The DPP enabled device of claim 7, wherein the first DPP enabled device and the second DPP enabled device is one of a wireless station or access point.

13. A computer-readable medium storing computer executable code for wireless communications, comprising code for:
receiving, at a first device provisioning protocol (DPP) enabled device, an authentication request from a second DPP enabled device to initiate an authentication protocol, wherein the authentication request identifies a bootstrapping method selected from a plurality of bootstrapping methods;
determining an authentication key in response to the identification of the bootstrapping method; and
applying the authentication key to unlock protected bootstrapping information that is included in the authentication request.

14. The computer-readable medium of claim 13, further comprising code for:
determining that the protected bootstrapping information was successfully unlocked using the authentication key;
authenticating, as part of the authentication protocol, the second DPP enabled device based on the protected bootstrapping information; and
transmitting an authentication response message to the second DPP enabled device. device and the second DPP enabled device is one of a wireless station or an access point.

15. An apparatus for wireless communication, comprising:
means for receiving, at a first device provisioning protocol (DPP) enabled device, an authentication request from a second DPP enabled device to initiate an authentication protocol, wherein the authentication request identifies a bootstrapping method selected from a plurality of bootstrapping methods;
means for determining an authentication key in response to the identification of the bootstrapping method; and
means for applying the authentication key to unlock protected bootstrapping information that is included in the authentication request.

16. The apparatus of claim 15, wherein the bootstrapping method selected from the plurality of bootstrapping methods is associated with a hash value included in the authentication request.

17. The apparatus of claim 15, further comprising:
means for aborting the authentication protocol in response to determining that the protected bootstrapping information was not successfully unlocked using the authentication key.

18. The apparatus of claim 15, further comprising:
means for determining that the protected bootstrapping information was successfully unlocked using the authentication key;
means for authenticating, as part of the authentication protocol, the second DPP enabled device based on the protected bootstrapping information; and
means for transmitting an authentication response message to the second DPP enabled device.

19. The apparatus of claim 15, wherein the means for determining the authentication key in response to the identification of the bootstrapping method further comprises:
means for correlating each of the plurality of bootstrapping methods with a plurality of authentication keys; and
means for identifying the authentication key from the plurality of authentication keys that corresponds with the bootstrapping method identified in the authentication request.

20. The apparatus of claim 15, wherein the first DPP enabled device and the second DPP enabled device is one of a wireless station or an access point.
